(19) United States
(12) Patent Application Publication
(10) Pub. No.: US 2023/0150445 A1
(43) Pub. Date: May 18, 2023

(54) COMPRESSED-AIR MODULE SYSTEM FOR A UTILITY VEHICLE

(71) Applicant: MAN Truck & Bus SE, München (DE)

(72) Inventor: Luis Vinzenz GESIERICH, MÜNCHEN (DE)

(73) Assignee: MAN Truck & Bus SE, München (DE)

(21) Appl. No.: 17/797,698

(22) PCT Filed: Jan. 19, 2021
(86) PCT No.: PCT/EP2021/051025

§ 371 Date: Aug. 4, 2022

(30) Foreign Application Priority Data
Feb. 4, 2020 (DE) 10 2020 000 730.9

(51) Int. Cl. B60R 16/08; B60R 11/00; B60T 17/02; B60T 17/06; F16M 13/02; F15B 13/02

(52) U.S. Cl. CPC B60R 16/08; B60R 11/00; B60T 17/02; B60T 17/06; F16M 13/02; F15B 13/02; B60R 2011/004; B60T 17/002

(57) ABSTRACT

The invention relates to a compressed-air module system for a utility vehicle, comprising a plurality of compressed-air components (46-58) and a mounting device (26) which can be attached to a vehicle frame (10) of the utility vehicle. The mounting device (26) and at least some of the plurality of compressed-air components (46-58) can be combined into a first compressed-air module (24A), wherein the first compressed-air module (24A) comprises an air compressor (56). The mounting device (26) and at least some of the plurality of compressed-air components (46-58) can be combined into a second compressed-air module (24B), wherein the second compressed-air module (24B) comprises, in place of the air compressor (56), at least one compressed air reservoir (58) from the plurality of compressed-air components (46-58).

The present disclosure relates to a compressed-air module system for a utility vehicle having a plurality of compressed-air components and a carrying apparatus.

US 2007/0234904 A1 discloses a dry compressed-air module for fastening to the frame of a utility vehicle. The dry compressed-air module consists of a housing, an air compressor, an air dryer, and a reservoir. The air compressor, the air dryer, and the reservoir are arranged in a housing and can be fastened together with the housing to the frame. The air dryer is supplied with compressed air from the air compressor and the reservoir is supplied with dry compressed air from the air dryer. The vessel is capable of storing the dry compressed air and of supplying same to the utility vehicle.

DE 195 38 339 A1 discloses an apparatus for generating and keeping compressed air ready for supplying compressed-air consumers in motor vehicles. The apparatus has a drive device, a compression apparatus, and a pressure store. The drive device, the compression apparatus, and the pressure store are combined to form a unit having a common, compact housing and are connected to one another without pressure lines.

EP 0 926 034 A2 discloses an apparatus for installing compressed-air vessels on a vehicle frame, with a holding device which is fastenable to the vehicle frame and which is provided on its circumference with cutouts for receiving the compressed-air vessels in a parallel arrangement, and with tensioning straps which are guided around the compressed-air vessels and hold the latter in the receptacles.

The present disclosure is based on the object of creating an alternative and/or improved technique for constructing a compressed-air module.

The object is achieved by the features of the independent claims. Advantageous developments are indicated in the dependent claims and the description.

One aspect of the present disclosure relates to a compressed-air module system for a utility vehicle, preferably a lorry. The modular system has a plurality of compressed-air components and a carrying apparatus which can be attached to a vehicle frame of the utility vehicle. The carrying apparatus and at least some (e.g. a first) of the plurality of compressed-air components can be combined to form a first compressed-air module, wherein the first compressed-air module has an air compressor, at least one compressed-air reservoir, and a compressed-air conditioning means of the plurality of compressed-air components. The carrying apparatus and at least some (e.g. a second) of the plurality of compressed-air components can be combined to form a second compressed-air module, wherein the second compressed-air module has the at least one compressed-air vessel and the compressed-air conditioning means and, instead of the air compressor, at least one further compressed-air vessel of the plurality of compressed-air components.

The modular system can afford the advantage that two compressed-air modules for different applications can be formed with a very large number of identical parts (e.g. carrying apparatus, at least one compressed-air vessel, compressed-air conditioning means). For example, the first compressed-air module can be used with the air compressor for utility vehicles operated by electric motor, and the second compressed-air module can be used with the further compressed-air vessel, instead of the air compressor, for utility vehicles operated by internal combustion engine. It is namely possible that the utility vehicle operated by internal combustion engine already has an air compressor integrated on the engine block of the internal combustion engine, and therefore the second compressed-air module does not require such an air compressor. In the modular system, it is therefore preferably provided that the air compressor is interchangeable with a compressed-air store. The compressed-air module can therefore be adapted to the type of drive of the vehicle. The external dimensions and all of the other (compressed-air) components can remain identical. This can have the advantage that the compressed-air module can always be used as a unit across all vehicle variants. This has a decisive influence on the development of the vehicles since the starting point can always be from a compressed-air module, and new variants do not have to be created for the individual types of drive. Production also profits from this disclosure since the mounting dimensions and the interfaces are always identical. An entire vehicle fleet consisting of utility vehicles operated by electric motor and by internal combustion engine can therefore be equipped with only two different compressed-air modules which also have a large number of identical parts since they are derived from the same modular system. This permits savings in many respects, e.g. development costs, production costs, installation costs, etc.

The at least one compressed-air vessel and the compressed-air conditioning means are preferably arranged identically in the first compressed-air module and in the second compressed-air module.

Preferably, the air compressor in the first compressed-air module is arranged identically to the at least one further compressed-air vessel in the second compressed-air module.

In one exemplary embodiment, the carrying apparatus is designed to carry the plurality of compressed-air components in a plurality of, preferably two, vertically spaced-apart planes. This can permit an advantageous use of construction space. In addition, it can be provided, for example, that one of the planes, e.g. an upper plane, is used for the air compressor and the at least one further compressed-air vessel, i.e. the interchangeable compressed-air components. A further plane, e.g. a lower plane, can preferably be used for the compressed-air components which are identical across the first and second compressed-air module (compressed-air conditioning means, at least one compressed-air vessel). This can simplify, for example, an unambiguous assignability of the compressed-air modules.

In a further exemplary embodiment, the carrying apparatus is designed to at least partially support the plurality of compressed-air components from below and to at least partially carry same in a suspended manner below the carrying apparatus. Such an arrangement uses only little construction space for the carrying apparatus and, in addition, makes it possible to combine a plurality of compressed-air components in the compressed-air modules.

In a further exemplary embodiment, the air compressor is supported, preferably by means of elastic damping elements, on the carrying apparatus. For example, decoupling in terms of vibration can therefore be permitted.

In a further exemplary embodiment, the at least one further compressed-air vessel is supported, preferably rigidly, on the carrying apparatus.

In one embodiment, the at least one compressed-air vessel and/or the compressed-air conditioning means are/is carried in a suspended manner below the carrying apparatus.

In a further embodiment, the at least one compressed-air vessel comprises a first compressed-air vessel and a second compressed-air vessel.

In one development, the first compressed-air vessel and/or the second compressed-air vessel in the first compressed-air module have/has a different function than in the second compressed-air module. It is therefore possible to react to the respective utility-vehicle-specific requirements (e.g. pneumatically actuated transmission—yes/no) and, for example, also take into consideration that the second compressed-air module has the further compressed-air vessel.

In a further embodiment, the first compressed-air vessel is arranged, preferably centrally, between the second compressed-air vessel and the compressed-air conditioning means, preferably in a suspended manner on the carrying apparatus. This can make it possible for the compressed-air conditioning means to be arranged in an easily accessible manner on the outside of the carrying apparatus, which permits simple exchange of worn parts and an easy connection of fluid lines to the compressed-air conditioning means.

In a further embodiment, the first compressed-air vessel protrudes beyond the carrying apparatus (e.g. towards the vehicle or under the vehicle frame) with respect to a transverse axis of the carrying apparatus (e.g. parallel to a transverse axis of the vehicle frame or of the utility vehicle). Therefore, unused construction space below the vehicle frame can be used and additional construction space created for the compressed-air conditioning means and the second compressed-air vessel.

In one embodiment variant, in the case of the first compressed-air module, the first compressed-air vessel is assigned or can be assigned to a first brake circuit of the utility vehicle and/or the second compressed-air vessel is assigned or can be assigned to a second brake circuit of the utility vehicle.

In a further embodiment variant, in the case of the second compressed-air module, the first compressed-air vessel is assigned or can be assigned to the first brake circuit of the utility vehicle, the second compressed-air vessel is assigned or can be assigned to a pneumatic secondary consumer (e.g. transmission control or air suspension, etc.) of the utility vehicle, and/or the at least one further compressed-air vessel is assigned or can be assigned to the second brake circuit.

In a further embodiment variant, the carrying apparatus has a first, e.g. L-shaped, carrier and a second, e.g. L-shaped, carrier, which carriers are preferably connected to each other by at least one transverse element (e.g. transverse strut, plate). The first carrier and the second carrier are preferably designed as identical parts, and/or a plurality of transverse elements which are designed as identical parts are included. This can reduce the variation in the parts and the production costs and can also prevent erroneous installations. The L-shaped carriers can provide a large amount of construction space for arranging compressed-air components, e.g. above and below the L-shaped carriers.

In one exemplary embodiment, the carrying apparatus, preferably a horizontal limb of an L-shaped carrier of the carrying apparatus, has at least one, preferably rectangular, through hole through which a tensioning strap which carries a pressure vessel of the at least one pressure vessel is tensioned. A receptacle for the tensioning strap can therefore be directly integrated in the carrying apparatus. It is not necessary to fasten a separate holder for fastening the tensioning strap to the carrying apparatus.

In one development, the at least one through hole is rounded or chamfered in the region of contact with the tensioning strap. Alternatively or additionally, for example, a lower edge of the carrying apparatus can be rounded or chamfered in the region of contact with the pressure vessel. A risk of damage to the tensioning strap and the pressure vessel can therefore be reduced.

In a further exemplary embodiment, the carrying apparatus has at least one collar portion for placing flat on the vehicle frame, wherein the at least one collar portion is preferably reinforced by, preferably welded-on, supporting ribs.

In a further exemplary embodiment, the air compressor has an exchangeable filter, and the carrying apparatus has a reinforcing rib (e.g. diagonal strut and/or tension bar) with a cutout (e.g. depression, recess, notch, hole). The cutout creates an installation space which is required for exchanging the exchangeable filter, wherein the exchangeable filter should inevitably be guided through the cutout as it is being removed or fitted.

In a further exemplary embodiment, the compressed-air conditioning means has an air dryer, a pressure regulator, and/or a multi-circuit protection valve, preferably a four-circuit protection valve, preferably as an integrated device.

It is pointed out that the first compressed-air module disclosed herein and the second compressed-air module disclosed herein are also in each case disclosed individually and independently of the compressed-air module system.

A further aspect of the present disclosure relates to a utility vehicle driven by electric motor, preferably lorry, having the first compressed-air module which can be combined from the compressed-air module system, as disclosed herein.

The first compressed-air module is preferably fitted on a vehicle frame, e.g. ladder frame, of the utility vehicle, e.g. on the outside and/or between a front axle and a rear axle of the utility vehicle.

A further aspect of the present disclosure relates to a utility vehicle driven by an internal combustion engine, preferably lorry, having the second compressed-air module which can be combined from the compressed-air module system, as disclosed herein.

The second compressed-air module is preferably fitted to a vehicle frame, e.g. ladder frame, of the utility vehicle, e.g. on the outside and/or between a front axle and a rear axle of the utility vehicle.

The utility vehicle driven by an internal combustion engine particularly preferably has an internal combustion engine in which an air compressor is incorporated, preferably integrated.

The previously described preferred embodiments and features of the present disclosure can be combined with one another as desired. Further details and advantages of the present disclosure will be described below with reference to the attached drawings, in which:

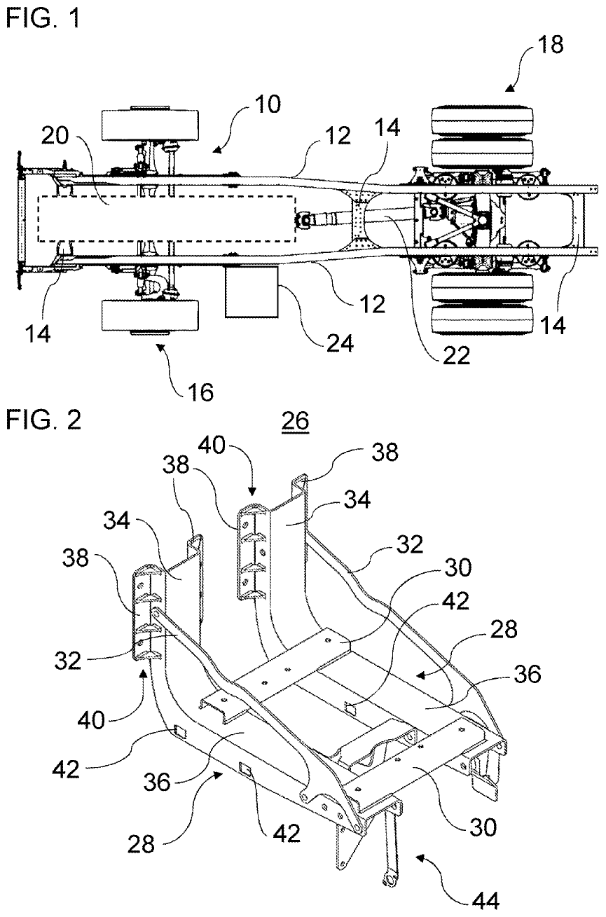

FIG. 1 shows a top view of a vehicle frame of a utility vehicle;

FIG. 2 shows a perspective view of an exemplary carrying apparatus of a compressed-air module;

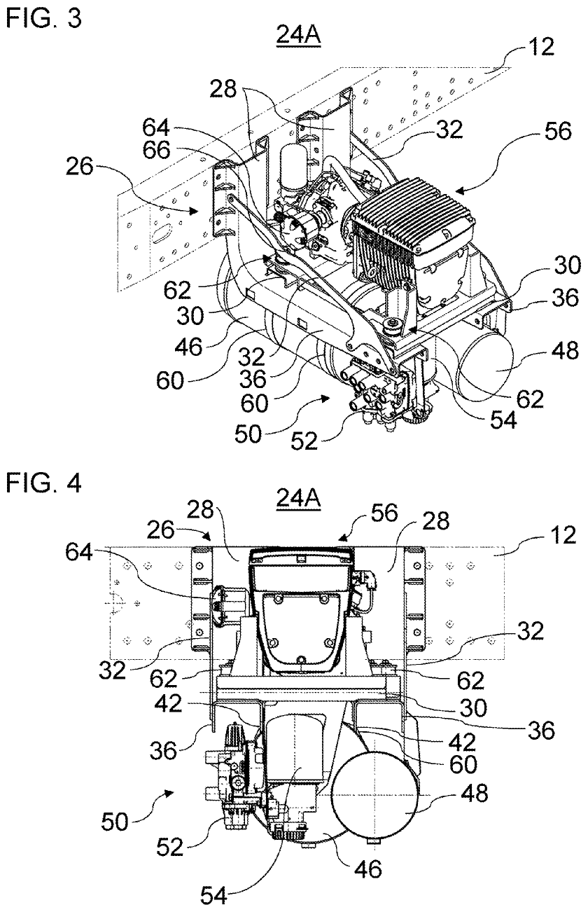

FIG. 3 shows a perspective view of an exemplary compressed-air module;

FIG. 4 shows a side view of the exemplary compressed-air module;

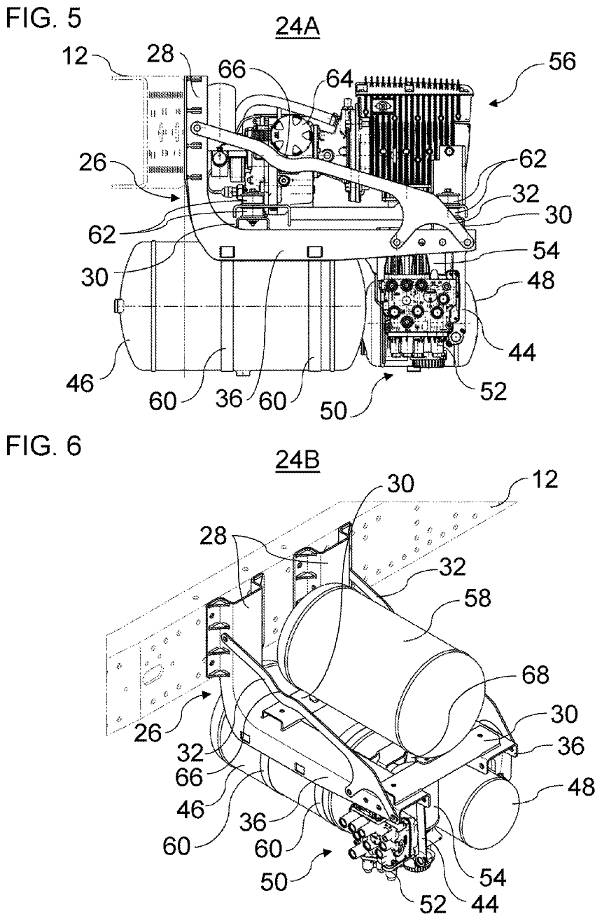

FIG. 5 shows a further side view of the exemplary compressed-air module;

FIG. 6 shows a perspective view of a further exemplary compressed-air module;

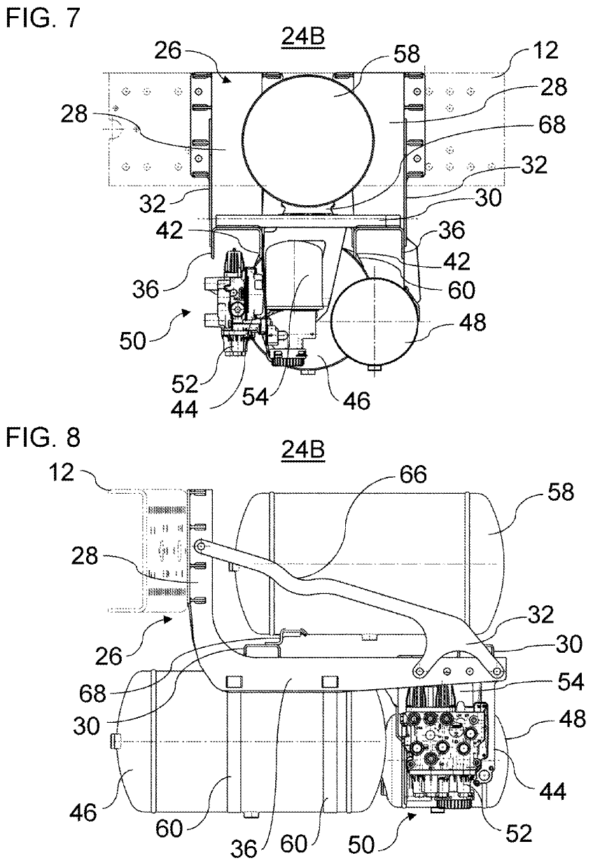

FIG. 7 shows a side view of the further exemplary compressed-air module;

FIG. 8 shows a further side view of the further exemplary compressed-air module; and

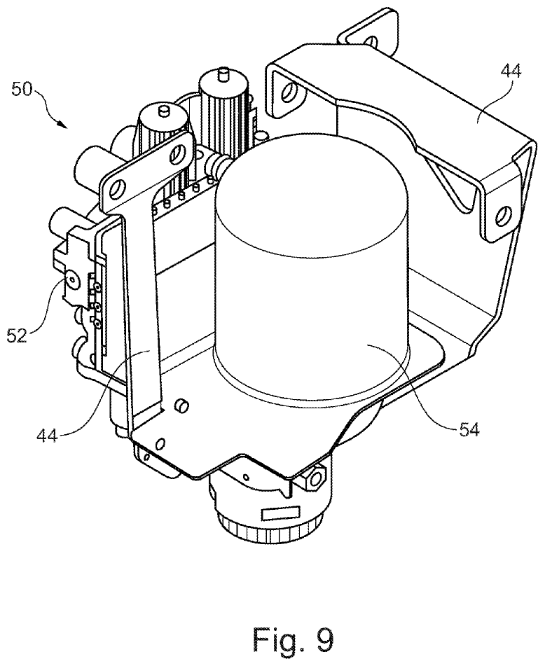

FIG. 9 shows a perspective view of a holder of the exemplary carrying apparatus for holding a compressed-air conditioning means.

The embodiments shown in the figures at least partially coincide, and therefore similar or identical parts are provided with the same reference signs and, for the explanation thereof, reference is also made to the description of the other embodiments or figures in order to avoid repetitions.

FIG. 1 shows a (vehicle) frame 10 of a utility vehicle. The utility vehicle is preferably in the form of a lorry. The frame 10 is in the form of a ladder frame. The frame 10 has two longitudinal members 12. The two longitudinal members 12 run substantially parallel to each other. The two longitudinal members 12 are connected to each other by means of a plurality of crossmembers 14. It is also possible for the frame 10 to be, for example, in the form of a lattice frame, rather than a ladder frame. The frame 10 can be supported on a plurality of axles of the utility vehicle, for example on a front axle 16 and a rear axle 18, as is illustrated in FIG. 1.

Depending on the design, the utility vehicle can be, for example, a utility vehicle driven by electric motor or a utility vehicle driven by an internal combustion engine. The drive device 20 (optionally with transmission, power electronics, etc.) can be arranged, for example, in a front region of the frame 10. The drive device 20 is, for example, connected in terms of drive to a propeller shaft 22 for driving the rear axle 18. It goes without saying that drive concepts without a central drive device are included by the present disclosure, for example wheel hub motors, motors close to the wheels, etc.

The frame 10 carries a compressed-air module 24. The compressed-air module 24 is preferably attached to an outer side of the frame 10, particularly preferably to the outer side of one of the longitudinal members 12 of the frame 10. Particularly advantageous in terms of installation and construction space, the compressed-air module 24 is arranged, for example, between the front axle 16 and the rear axle 18. The compressed-air module 24 combines a multiplicity of compressed-air-related functions in itself, as is described herein in more detail by way of example.

A particular feature of the present disclosure consists in that the compressed-air module 24 can be combined or assembled from a modular system. At least two different variants of the compressed-air module 24 can preferably be provided by means of the modular system. The first variant of the compressed-air module 24 (also called first compressed-air module 24A herein) is provided for use in a utility vehicle driven by electric motor. The second variant of the compressed-air module 24 (also called second compressed-air module 24B herein) is provided for use in a utility vehicle driven by an internal combustion engine. Details in this regard will be herein explained, for example, further on with reference to FIGS. 3 to 8.

FIG. 2 shows an exemplary carrying apparatus 26 of the compressed-air module 24 from FIG. 1. The carrying apparatus 26 can provide the particular characteristic that it is usable as an identical part for a plurality of compressed-air modules 24 which can be combined from the modular system.

The carrying apparatus 26 is designed to be fastened to the frame 10 of the utility vehicle. The carrying apparatus 26 can have, for example, two carriers 28, two transverse struts 30, and optionally two reinforcing struts 32. It is possible for the carrying apparatus to have a different number of carriers 28, transverse struts 30, and/or reinforcing struts 32. In the case of a plurality of carriers 28, in the case of a plurality of transverse struts 30, and/or in the case of a plurality of reinforcing struts 32, they can each be designed as identical parts.

The carriers 28 are preferably designed as L-shaped carriers. Each carrier 28 can have a vertical limb 34 and a horizontal limb 36. The carriers 28 can be designed, for example, as sheet-metal drawn parts (e.g. deep-drawn part) or as welded structures.

The vertical limb 34 of the carrier 28 is fastened to the frame 10, for example by means of releasable screw connections. The vertical limb 34 can have, for example, a U-shaped cross section. The vertical limb 34 can have a collar portion 38. The collar portion 38 can be reinforced by supporting ribs 40 which are preferably welded into place. The collar portion 38 can have through holes which serve for fastening the carrier 28 to the frame 10.

The horizontal limb 36 of the carrier 28 is designed to carry a plurality of compressed-air components. The carrier 28 can carry compressed-air components in a plurality of planes. For example, compressed-air components can be supported above the horizontal limbs 36. Compressed-air components can also be carried in a suspended manner on the horizontal limbs 36. The horizontal limbs 36 of the carriers 28 can be connected to one another by the transverse struts 30. For example, the transverse struts 30 can be welded onto the carriers 28. The transverse struts 30 can likewise carry compressed-air components.

The horizontal limb 36 can have a U-shaped cross section. The horizontal limb 36 preferably has at least one, preferably rectangular, through hole 42. Through the through hole 42, it is possible for a tensioning strap (not illustrated in FIG. 2) to be guided, with which a compressed-air component (e.g. compressed-air vessel) can be carried, preferably in a suspended manner below the carrier 28. Preferably, a plurality of through holes 42 for a plurality of tensioning straps can be included. Preferably, mutually aligned through holes 42 in the two horizontal limbs 36 for the passage of the same tensioning strap can also be included. A plurality of connection points for the same tensioning strap can therefore be created.

The reinforcing struts 32 can connect the horizontal limb 36 and the vertical limb 34 to each other. The reinforcing struts 32 serve as tension bars and, for example, can bring about a uniform introduction of force into the limbs 34 and the frame 10. The reinforcing struts can extend diagonally between the limbs 34 and 36.

Optionally, at least one holder 44 for holding one or more compressed-air components can also be attached to the carrier 28. The holder 44 is fastened in a suspended manner to the carrier 28. The holder 44 is arranged below the carrier 28.

FIGS. 3 to 5 show the first compressed-air module 24A. FIGS. 6 to 8 show the second compressed-air module 24B. The two compressed-air modules 24A, 24B can be combined from the modular system, with the carrying apparatus 26 being used as an identical part.

The two compressed-air modules 24A, 24B have a plurality of compressed-air components which are partially used as identical parts. It is possible for at least one compressed-air component used as an identical part in the case of the first compressed-air module 24A and in the case of the second compressed-air module 24B to have a different function.

The two compressed-air modules 24A, 24B have a (first) compressed-air vessel 46, a (second) compressed-air vessel 48, and a compressed-air conditioning means 50 with, for example, a compressed-air valve device 52 and an air dryer 54. The first compressed-air module 24A additionally has an air compressor 56. Instead of the air compressor 56, the second compressed-air module 24B has a (third) compressed-air vessel 58.

The first compressed-air module 24A is intended for use with a utility vehicle driven by an electric motor. The second compressed-air module 24B is intended for use with a utility vehicle driven by an internal combustion engine. The utility vehicle which is driven by an internal combustion engine can namely already have an air compressor integrated in its drive device 20. For example, a compressor housing can be cast together with an engine block of the internal combustion engine (=drive device 20). It is therefore not required for the second compressed-air module 24B to have an air compressor. In contrast thereto, in the case of the utility vehicle driven by an electric motor, an air compressor cannot be integrated in the drive device 20. It is therefore preferred that the first compressed-air module 24A has the air compressor 56. In the case of the second compressed-air module 24B, the compressed-air vessel 58 can be arranged in place of an air compressor. The arrangement of the compressed-air vessel also makes sense for construction space reasons since there is a relatively large amount of construction space in the region in which the air compressor 56 is arranged in the case of the first compressed-air module 24A. By means of the arrangement of the compressed-air vessel, further compressed-air-related functions can be integrated in the second compressed-air module 24B.

The compressed-air vessel 46 is structurally identical and arranged identically in the case of the first compressed-air module 24A and in the case of the second compressed-air module 24B. In both compressed-air modules 24A, 24B, the compressed-air vessel 46 can be assigned to a brake circuit of the utility vehicle, for example to a front-axle brake circuit. The compressed-air vessel 46 is arranged in a suspended manner below the carrying apparatus 26, preferably centrally. A plurality of tensioning straps 60 can carry the compressed-air vessel 46 centrally between the carriers 28 by way of the opposite through holes 42 (see FIGS. 4 and 7) in the horizontal limbs 36. The compressed-air vessel 46 can be, for example, a 40 litre compressed-air vessel.

In order to prevent damage to the tensioning straps 60, the, preferably rectangular, through holes 42 can be chamfered or rounded, preferably in portions which lie directly on the tensioning straps 60. In order to prevent damage to the compressed-air vessel 46, a lower edge of the limb 36 that is in contact with the compressed-air vessel 46 can be chamfered or rounded.

The compressed-air vessel 46 can be arranged with an end portion directly below the longitudinal member 12 in order, for example, to create more construction space for the compressed-air vessel 48 and the integrated compressed-air conditioning means 50 (see FIGS. 5 and 8). In other words, the compressed-air vessel 46 protrudes beyond the carrying apparatus 26 with respect to a transverse axis of the carrying apparatus 26. The compressed-air vessel 48 and the compressed-air conditioning means 50 can be arranged on opposite sides of the compressed-air vessel 46.

The compressed-air vessel 48 is structurally identical and arranged identically in the case of the first compressed-air module 24A and in the case of the second compressed-air module 24B. However, the compressed-air vessel 48 can carry out a different function in the case of the first compressed-air module 24A than in the case of the second compressed-air module 24B. For example, the compressed-air vessel 48 in the case of the first compressed-air module 24A can be assigned to a second brake circuit of the utility vehicle, for example to a rear axle brake circuit. By contrast, in the case of the second compressed-air module 24B, the compressed-air vessel 48 can be assigned, for example, to a pneumatic transmission control for a transmission, for example automatic transmission. The compressed-air vessel 48 can also be assigned, for example, to another pneumatic secondary consumer, e.g. to an air suspension of the utility vehicle. The compressed-air vessel 48 is arranged in a suspended manner below the carrying apparatus 26, for example by means of a tensioning strap (not illustrated) on a holder which is fastened to the carrier 28. The compressed-air vessel 48 can be, for example, an 8 litre compressed-air vessel.

FIG. 9 shows the compressed-air conditioning means 50 in greater detail. The compressed-air conditioning means 50 is structurally identical and arranged identically in the case of the first compressed-air module 24A and in the case of the second compressed-air module 24B. The air dryer 54 is designed to dehumidify air. The air dryer 54 can have an exchangeable cartridge. The compressed-air valve device 52 can have, for example, a pressure regulator, nonreturn valves, and a multi-circuit protection valve for the different compressed-air circuits, preferably brake circuits, of the utility vehicle.

The compressed-air conditioning means 50 is fastened in a suspended manner to the carrying apparatus 26 by means of the holder 44. The compressed-air conditioning means 50 is arranged below the carrying apparatus 26. The holder 44 can be connected to the compressed-air conditioning means 50 at a plurality of connection points. The holder 44 is furthermore connected to the horizontal limbs 36 at a plurality of connection points. The compressed-air conditioning means 50 can therefore be securely held from a plurality of sides.

The air compressor 56 of the first compressed-air module 24A compresses air to form compressed air. The air compressor 56 can have a compressor part and a drive part. The air compressor 56 is carried on the horizontal limbs 36 and the transverse struts 30. The air compressor 56 is arranged above the horizontal limbs 36 and the transverse struts 30. The air compressor 56 is preferably supported on the carrying apparatus 26 in a damped manner by means of elastic damping elements 62. The air compressor 56 can be supported by the damping elements 62, for example by means of a four-point mounting. The damping elements 62 can decouple the air compressor 56 in terms of vibration from the carrying apparatus 26 and therefore from the frame 10. The air compressor 56 can be oriented in such a manner that the solid cooling fins of the drive part of the air compressor 56 are mounted towards the outside. The solid drive part can therefore carry out a certain protective function.

The air compressor 56 of the first compressed-air module 24A can have an exchangeable filter 64, preferably an air filter or an oil filter. In order to create sufficient installation space for exchanging the filter 64, the reinforcing strut 32 can have a cutout 66, e.g. in the form of a notch, depression or a through hole. For the exchange, the filter 64 can be guided through or along the cutout 66, e.g. parallel to the longitudinal axis of the utility vehicle (cf. FIG. 5).

The compressed-air vessel 58 of the second compressed-air module 24B is carried on the horizontal limbs 36 and the transverse struts 30, e.g. by means of intermediately arranged holders 68 which are supported on the transverse struts 30. The compressed-air vessel 58 can be fastened to the holders 68 by means of tensioning straps (not illustrated). The compressed-air vessel 58 is arranged above the horizontal limbs 36 of the transverse strut 30. The compressed-air vessel 58 can expediently be assigned to a rear axle brake circuit of the utility vehicle. The compressed-air vessel 58 can be, for example, a 40 litre compressed-air vessel.

The present disclosure is not restricted to the preferred exemplary embodiments described above. On the contrary, a multiplicity of variants and modifications are possible which likewise make use of the inventive concept and therefore fall within the scope of protection. In particular, the present disclosure also claims protection for the subject matter and the features of the dependent claims irrespective of the claims referred to. In particular, the individual features of independent claim 1 are in each case disclosed independently of one another. In addition, the features of the dependent claims are also disclosed independently of all of the features of independent claim 1.

### LIST OF REFERENCE SIGNS

10 Frame
12 Longitudinal member
14 Crossmember
16 Front axle
18 Rear axle
20 Drive device
22 Propeller shaft
24 Compressed-air module
24A First compressed-air module
24B Second compressed-air module
26 Carrying apparatus
28 Carrier
30 Transverse strut
32 Reinforcing strut
34 Vertical limb
36 Horizontal limb
38 Collar portion
40 Supporting ribs
42 Through hole
44 Holder
46 Compressed-air vessel
48 Compressed-air vessel
50 Compressed-air conditioning means
52 Compressed-air valve device
54 Air dryer
56 Air compressor
58 Compressed-air vessel
60 Tensioning strap
62 Damping element
64 Filter
66 Cutout
68 Holder

1. A compressed-air module system for a utility vehicle having:
a plurality of compressed-air components;
a carrying apparatus, which can be attached to a vehicle frame of the utility vehicle,
wherein:
the carrying apparatus and at least some of the plurality of compressed-air components can be combined to form a first compressed-air module, wherein the first compressed-air module has an air compressor, at least one compressed-air vessel, and a compressed-air conditioning means of the plurality of compressed-air components; and
the carrying apparatus and at least some of the plurality of compressed-air components can be combined to form a second compressed-air module, wherein the second compressed-air module has the at least one compressed-air vessel and the compressed-air conditioning means, and, instead of the air compressor, at least one further compressed-air vessel of the plurality of compressed-air components.

2. The compressed-air module system according to claim 1, wherein:
the carrying apparatus is designed to carry the plurality of compressed-air components in a plurality of vertically spaced-apart planes; and/or
the carrying apparatus is designed to at least partially support the plurality of compressed-air components from below and at least partially to carry same in a suspended manner below the carrying apparatus.

3. The compressed-air module system according to claim 1, wherein:
the air compressor is supported on the carrying apparatus; and
the at least one further compressed-air vessel is supported on the carrying apparatus.

4. The compressed-air module system according to claim 1, wherein:
the at least one compressed-air vessel and/or the compressed-air conditioning means are/is carried in a suspended manner below the carrying apparatus.

5. The compressed-air module system according to claim 1, wherein:
the at least one compressed-air vessel comprises a first compressed-air vessel and a second compressed-air vessel.

6. The compressed-air module system according to claim 5, wherein:
the first compressed-air vessel and/or the second compressed-air vessel have/has a different function in the first compressed-air module than in the second compressed-air module; and/or
the first compressed-air vessel is arranged between the second compressed-air vessel and the compressed-air conditioning means; and/or
the first compressed-air vessel protrudes beyond the carrying apparatus with respect to a transverse axis of the carrying apparatus.

7. The compressed-air module system according to claim 5, wherein:
in the case of the first compressed-air module, the first compressed-air vessel is assigned or can be assigned to a first brake circuit of the utility vehicle and the second compressed-air vessel is assigned or can be assigned to a second brake circuit of the utility vehicle; and
in the case of the second compressed-air module, the first compressed-air vessel is assigned or can be assigned to the first brake circuit of the utility vehicle, the second compressed-air vessel is assigned or can be assigned to a pneumatic secondary consumer of the utility vehicle, and the at least one further compressed-air vessel is assigned or can be assigned to the second brake circuit.

8. The compressed-air module system according to claim 1, wherein:
the carrying apparatus has a first L-shaped carrier and a second L-shaped carrier, which carriers are connected to each other by at least one transverse element.

9. The compressed-air module system according to claim 1, wherein:
the carrying apparatus has at least one through hole through which a tensioning strap which carries a pressure vessel of the at least one pressure vessel is tensioned.

10. The compressed-air module system according to claim 9, wherein:
the at least one through hole is rounded or chamfered in the region of contact with the tensioning strap; and/or
a lower edge of the carrying apparatus is rounded or chamfered in the region of contact with the pressure vessel.

11. The compressed-air module system according to claim 1, wherein:
the carrying apparatus has at least one collar portion for placing flat on the vehicle frame, wherein the at least one collar portion is reinforced by supporting ribs.

12. The compressed-air module system according to claim 1, wherein:
the air compressor has an exchangeable filter; and
the carrying apparatus has a reinforcing strut with a cutout, wherein the cutout creates an installation space which is required for exchanging the exchangeable filter, wherein the exchangeable filter should inevitably be guided through the cutout as it is being removed or fitted.

13. The compressed-air module system according to claim 1, wherein:
the compressed-air conditioning means has an air dryer, a pressure regulator and/or a multi-circuit protection valve.

14. A utility vehicle driven by electric motor having:
the first compressed-air module which is combined from the compressed-air module system according to one of the preceding claims.

15. A utility vehicle which is driven by an internal combustion engine having:
the second compressed-air module which is combined from the compressed-air module system according to claim 1.

16. The utility vehicle of claim 15, wherein the utility vehicle is a lorry.

17. The utility vehicle of claim 14, wherein the utility vehicle is a lorry.

18. The compressed-air module system according to claim 1, wherein:
the utility vehicle is a lorry: and/or
the carrying apparatus is designed to carry the plurality of compressed-air components in two vertically spaced-apart planes; and/or
the air compressor is supported by means of elastic damping elements on the carrying apparatus; and/or
the at least one further compressed-air vessel is rigidly supported on the carrying apparatus; and/or
the carrying apparatus has at least one collar portion for placing flat on the vehicle frame, wherein the at least one collar portion is welded-on supporting ribs; and/or
the compressed-air conditioning means has an air dryer, a pressure regulator, and/or a four-circuit protection valve.

19. The compressed-air module system according to claim 1, wherein the carrying apparatus has a first L-shaped carrier and a second L-shaped carrier, which carriers are connected to each other by at least one transverse element, wherein:
the first L-shaped carrier and the second L-shaped carrier are designed as identical parts; and/or
the at least one transverse element is a plurality of transverse elements which are designed as identical parts; and/or
a horizontal limb of at least one of the first or second L-shaped carriers has at least one rectangular through hole through which a tensioning strap which carries a pressure vessel of the at least one pressure vessel is tensioned.

20. The compressed-air module system according to claim 5, wherein the first compressed-air vessel is arranged centrally between the second compressed-air vessel and the compressed-air conditioning means in a suspended manner on the carrying apparatus.
